(19) United States
(12) Patent Application Publication
(10) Pub. No.: US 2018/0267691 A1
(43) Pub. Date: Sep. 20, 2018

(54) METHOD AND SYSTEM FOR GENERATING AUDIO ASSOCIATED WITH A USER INTERFACE

(71) Applicant: Tempo Music Design Oy, Helsinki (FI)

(72) Inventors: Vesa-Matti Mattsson, Espoo (FI); Jussi Aronen, Espoo (FI)

(21) Appl. No.: 15/926,350

(22) Filed: Mar. 20, 2018

(30) Foreign Application Priority Data
Mar. 20, 2017 (FI) 20175249

(51) Int. Cl. G06F 3/0484; G06F 3/033; G06F 3/16

(52) U.S. Cl. CPC G06F 3/04842; G06F 3/167; G06F 3/033

(57) ABSTRACT

A method of providing audio cues to a user of a content, the content being presented to the user on a computing device, the content including an interactive user interface element. The method includes identifying a location at which the interactive user interface element is displayed on a display of the computing device. Further, the method includes determining a current location of a pointer on the display with respect to the location at which the interactive user interface element is displayed on the display of the computing device. Furthermore, the method includes generating an audio signal based upon a relative location of the pointer with respect to the interactive user interface element.

### TECHNICAL FIELD

The present disclosure relates generally to user interfaces of computing systems; and more specifically, to methods and systems for generating audio associated with a user interface.

### BACKGROUND

A user interface is an important part of a computer that allows users to interact with the computer. Generally, the user interface includes one or more of an input device and an output device. For example, a Graphical User Interface (GUI) is commonly used in computers for allowing the user to view and interact with graphical elements displayed on a display device. Accordingly, the interaction is typically performed using a combination of an input device, such as a mouse and an output device, such as a display device.

Further, in order to enhance user experience, user interfaces commonly employ multiple output devices in conjunction. For example, presentation of and/or interaction with a GUI element may be accompanied by playing of a corresponding sound on a sound generating device. Another objective of such multi-modal user interfaces is that users suffering from various forms of visual impairment may be enabled to successfully operate the computer by listening to the sounds associated with the user interface.

Accordingly, existing methods and systems enable designers of user interfaces to associate sounds with GUI elements. For example, existing programming languages allow developers to associate a sound with an element, such as, a link or an image of a web page. As an example, the following code enables playing of a sound when a mouse is hovered over the link “about.htm” in the web site: <ahref=“about.htm” onmouseover=“playclip( )”>Mouseover Sound Link</a><br>. Similarly, in order to play a sound upon a mouseover on an image “sound-image.jpg”, the following code may be used: <ahref=“about.htm” onmouseover=“playclip( )”><img src=“picts/sound-image.jpg” width=“125” height=“125” border=“0” alt=“image”></a><br>. Accordingly, the start of a corresponding HTML code may include the following code: <script type=“text/javascript” src=“sound-mouseover.js”></script>. Further, the end of the HTML code may include the code: <audio><source src=“click.mp3”></audio><div id=“sounddiv”><bgsound id=“sound”></div>

However, a limitation with existing techniques is that multiple sounds may not be played in relation to a GUI element. Accordingly, for example, if an image has different areas, currently, different sounds cannot be associated with those areas of the image. Further, while existing methods allow for associating a sound with a GUI element for interaction such as clicking or hovering on the GUI element, they do not allow for associating sounds with user interactions occurring outside the GUI element, such as, for example, when a mouse cursor is in vicinity of the GUI element.

Therefore, in light of the foregoing discussion, there exists a need to overcome the aforementioned drawbacks by improved methods and systems for associating sounds with user interface elements.

### SUMMARY

The present disclosure seeks to provide a method of providing audio cues to a user of a content. One aim of the present disclosure is to provide a method where sounds can be associated with user interactions occurring outside an interactive user interface element in user interface. Another aim is to at least partially overcome problems in prior art.

In one aspect, an embodiment of the present disclosure provides a method of providing audio cues to a user of a content, the content being presented to the user on a computing device, the content comprising an interactive user interface element, wherein the method comprises:
identifying a location at which the interactive user interface element is displayed on a display of the computing device;
determining a current location of a pointer on the display with respect to the location at which the interactive user interface element is displayed on the display of the computing device; and
generating an audio signal based upon a relative location of the pointer with respect to the interactive user interface element.

In another aspect, an embodiment of the present disclosure provides a computer program product comprising a non-transitory machine-readable data storage medium having stored thereon program instructions that, when accessed by a processing device, cause the processing device to:
identify a location at which the interactive user interface element is displayed on a display of the computing device;
determine a current location of a pointer on the display; and
generate an audio signal based upon a relative location of the pointer with respect to the interactive user interface element.

Embodiments of the present disclosure substantially eliminate or at least partially address the aforementioned problems in the prior art and enables different zones of an interactive user interface element, such as an image, to be associated with different audio. Accordingly, when a user action such as a mouse hovering or a mouse click occurs in a zone associated with the interactive user interface element, an audio associated with the interactive user interface element generated. As a result, a richer user experience may be delivered to user users in interacting with user interfaces. Further, users with various forms of visual impairment may be enabled to navigate user interfaces with greater convenience and/or accuracy.

Additional aspects, advantages, features and objects of the present disclosure would be made apparent from the drawings and the detailed description of the illustrative embodiments construed in conjunction with the appended claims that follow. Any embodiment disclosed in connection with one of the methods may be applicable to the other method, even if not expressly stated.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a method providing audio cues to a user accessing a piece of content, in accordance with an embodiment;

FIG. 2 is a schematic illustration of a user interface comprising an image including a first area and a second area configured to respectively play a first audio file and a second audio file, in accordance with an embodiment;

FIG. 3 is a schematic illustration of a user interface comprising an image including a first area a second area and a third area outside the image configured to respectively play a first audio file, a second audio file and a third audio file, in accordance with an embodiment;

FIG. 4 is a schematic illustration of a user interface comprising an image including a plurality of areas associated with a plurality of audio files, in accordance with an exemplary embodiment;

FIG. 5 is a schematic illustration of a method of associating a plurality of areas of an image with a plurality of audio files, in accordance with an embodiment;

FIG. 6 is a schematic illustration of user interaction with a user interface comprising an image including a plurality of areas and associated plurality of audio files, in accordance with an exemplary embodiment;

FIG. 7 is a schematic illustration of a user interface comprising an image including a first plurality of areas within the image and a second plurality of areas outside the image, wherein each of the first plurality of areas and the second plurality of areas are associated with a plurality of audio files, in accordance with an embodiment and

FIG. 8 is a schematic illustration of a user interface comprising an image including a plurality of areas outside the image, wherein each of the plurality of areas is associated with a predetermined volume level, in accordance with an embodiment.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method of providing audio cues to a user of a content, the content being presented to the user on a computing device, the content comprising an interactive user interface element. The method of providing the audio cues to the user of the content includes identifying a location at which the interactive user interface element is displayed on a display of the computing device, determining a current location of a pointer on the display with respect to the location at which the interactive user interface element is displayed on the display of the computing device and generating an audio signal based upon a relative location of the pointer with respect to the interactive user interface element.

According to embodiments the content can refer to a content rendered in a user interface of a computer, laptop, webpad, smartphone, portable computing device or alike. The content can be a webpage content (for example implemented with hypertext mark up language HTML) or it can be application such as a news reader application, image/video viewing application, social media application or gaming application running etc. in a smart phone or other computing environment. A pointer can refer to a mouse, finger, stylus etc. The user of the content refers to a person accessing the content online, offline or via an application.

In another aspect, an embodiment of the present disclosure provides a computer program product comprising non-transitory machine-readable data storage medium having stored thereon program instructions that, when accessed by a processing device, cause the processing device to:
identify a location at which the interactive user interface element is displayed on a display of the computing device;
determine a current location of a pointer on the display with respect to the location at which the interactive user interface element is displayed on the display of the computing device; and
generate an audio signal based upon a relative location of the pointer with respect to the interactive user interface element.

In an embodiment of the present disclosure, the interactive user interface element in general may include any means configured to enable a user to interact with a computer. In an instance, the interactive user interface element may include one or more of an input device and an output device. Examples of the input device may include, but are not limited to, a keyboard, a mouse, a trackpad, a touchscreen, a joystick, gesture detector, gaze detector etc. Examples of the output device may include, but are not limited to, a display device, a sound generating device, electro-mechanical actuators etc.

Accordingly, in an example, the interactive user interface may include a Graphical User Interface (GUI) implemented using each of the input device and the output device in cooperation with the computer. The GUI may include a plurality of interactive user interface elements configured to perform one or more of presentation of information to a user and receiving an input from the user. For instance, the plurality of user interface elements may include, but are not limited to, text, text box, image, radio control, action button, slider, scroll-bars, menu, toolbar, window, dialog box etc.

Further, the interactive user interface element may be configured to enable a user of the computer to interact with the user interface. Accordingly, the user interface may be configured to capture and/or receive inputs from the user. For example, the GUI may provide one or more interactive elements such as, but not limited to, a hyperlinked user interface element, an action button, a menu etc. Further, the GUI may be configured to be controlled based on inputs received from the mouse. Accordingly, the GUI may include display of a mouse pointer whose position and/or movement is controlled by a mouse. As a result, user actions such as, hovering the mouse pointer over a user interface element or performing a mouse click on the user interface element may be captured. Accordingly, one or more operations may be performed by the computer based on the user actions.

In order to provide an enhanced user experience, the audio element is generated for the user interface. Further, the audio element may be associated with a user interface element, such as, for example, an image included in the user interface. Further, the audio element may include the audio which may be generated using a sound generating device such as, but not limited to, speaker.

Accordingly, the method comprises identifying a location at which the interactive user interface element is displayed on a display of the computing device. In an embodiment, identifying the location at which the interactive user interface element is displayed may include assigning a reference value to the interactive user interface.

Accordingly, the method may include creating an interactive user interface element. In an embodiment, creating the interactive user interface element may include the receiving of an image from a computing device operated by a user, such as, for example, a developer of the user interface. Accordingly, in an instance, the developer of the user interface may be enabled to select the image from a data source, such as, a database. Consequently, the image may be retrieved from the database and presented on a display device associated with the computing device. Alternatively, the user interface comprising the image may be retrieved from the database and presented on the display device. For example, a webpage including the image may be retrieved from a web server and displayed on the display device. Additionally, the image may be associated with an image identifier. Accordingly, receiving of the image may be performed based on the image identifier.

In an embodiment, the method of creating the interactive user interface may comprise defining a first area within the image. In general, the defining includes specifying one or more spatial characteristics of the first area. In an embodiment, the defining of the first area may be performed by a user, such as the developer of the user interface. Accordingly, the developer may demarcate the first area using an input device, such as, for example, a mouse. For example, a boundary selection tool may be provided to the developer for defining the first area. Using the boundary selection tool, the developer may define the first area in the form of any arbitrary shape. Alternatively, the developer may define the first area based on contents of the image. For example, the developer may trace a boundary of an object represented in the image in order to define the first area. Further, predefined boundary shapes such as circle, square, rectangle, polygon, etc. may be presented to the developer in order to facilitate defining the first area. Accordingly, the developer may perform a drag and drop operation of a predefined boundary shape onto the image on an intended region. Further, the developer may be enabled to move the predefined boundary shape to a desired location on the image and optionally modify a size of the predefined boundary shape in order to define the first area according to the developer's intention.

Alternatively, in an embodiment, the defining of the first area may be automatically performed based on contents of the image. For instance, the image may be processed using an object recognition algorithm to identify one or more objects represented in the image. Accordingly, the first area may be defined as the boundary of at least one of the one or more objects. Further, in another embodiment, the developer may manually select an object from the one or more objects. Accordingly, the first area may be defined as the boundary of the object.

Further, in an embodiment, the defining of the first area may be automatically performed based on a predefined partition of the image. For example, the image may be partitioned into a plurality of regions of one or more dimensions. Additionally, one or more of the plurality of regions may be defined as the first area. For instance, the image may be partitioned into multiple identical tiles based on predetermined dimensions of the tiles or predetermined number of tiles. Further, a boundary of one of the multiple tiles may be defined as the first area.

In an embodiment, the defining of the first area may be visually highlighted in order to enable the developer to perceive the first area. For example, subsequent to defining the first area, the boundary of the first area may be visually highlighted by a dotted line.

Additionally, in an embodiment, subsequent to defining of the first area, a first area identifier corresponding to the first area may be created and stored in the storage device. For example, the first area identifier may include one or more coordinates of pixels in the image. Additionally, the first area identifier may include a user-defined label. In an instance, the developer may be enabled to provide the user-defined label.

Furthermore, in another embodiment, the method of creating the interactive user interface may comprise associating a first audio file with the first area. In general, the first audio file is a digital representation of a predetermined sound, such as for example, but not limited to, a speech message or a music. Accordingly, the first audio file is such that playback of the audio file using a sound generating device, such as a speaker, results in production of the predetermined sound. Accordingly, the first audio file may be stored in a storage device in one or more file formats, such as, but not limited to, WAV, MP3, PCM, AIFF, AAC, OGG, WMA, FLAC, ALAC etc. Further, the first audio file may be associated with a first audio identifier, such as, for example a file name.

Accordingly, in an embodiment, the associating of the first audio file with the first area may include selecting the first audio file from a plurality of audio files. The selecting may be performed by the developer of the user interface. Alternatively, in an embodiment, the first audio file may be selected automatically. For instance, the first audio file may be selected based on an object represented in the first area of the image. Accordingly, the image may be processed using the object recognition algorithm to identify the object. Further, the storage device may include a mapping between an object and at least one audio file corresponding to the object. For instance, the mapping may include a correspondence between an object identifier and file names of the at least one audio file. Accordingly, the first audio file may be automatically selected based on the object identified in the first area and the mapping.

Further, in an embodiment, a first association between the first audio file and the first area may be stored in the storage device in a suitable data structure. For example, a mapping between the file name of the first audio file and the area identifier associated with the first area may be stored in a table. Further, in an embodiment, the table may include a source identifier indicating a storage location where the first audio file is stored. For example, the source identifier may be in the form of a hyperlink of the first audio file stored in an external storage server.

Additionally, in an embodiment, the method of creating the interactive user interface element may comprise defining a second area within the image. Details regarding defining the second area may be understood from the foregoing description of defining the first area.

Further, in an embodiment, the method of creating the interactive user interface element may comprise associating a second audio file with the second area. Further, at least one auditory characteristic of the second audio file may be different from that of the first audio file. In an embodiment, each of the first audio file and the second audio file may be stored separate in a storage device. Alternatively, in another embodiment, each of the first audio file and the second audio file may be stored in different parts of a common file. Further details regarding associating the second audio file with the second area may be understood from the foregoing description of associating the first audio file with the first area. Accordingly, a second association between the second audio file and the second area may be created and stored in the storage device.

Furthermore, in another embodiment, the method of creating the interactive user interface element may comprise forming the audio element by defining a first handler for playing at least the first or the second audio file based on the associations. The audio element comprises the image, the first audio file, the second audio file, the first association and the second association. In an embodiment, the audio element may include the image identifier, the first audio identifier, a second audio identifier corresponding to the second audio file, the first association and the second association. Further, the first association may be in the form of the mapping between the first area identifier and the first audio file. Similarly, the second association may be in the form of a mapping between a second area identifier of the second area and the second audio file.

In an embodiment, the audio element may be represented as program code adhering to a predefined syntax. For example, the audio element may be represented using a scripting language such as Java or HTML. Accordingly, developers of the user interface may conveniently specify the audio element in the predefined syntax.

In an embodiment, defining the first handler may include a specification of one or more user interactions associated with one or more of the first area and the second area of the image. For example, a developer may be enabled to specify a first user interaction, such as a mouse hovering, to be associated with the first area. Similarly, the developer may be enabled to specify a second user interaction, such as a mouse click, to be associated with the second area. Accordingly, the first handler may be configured for playing at least one of the first audio and the second audio based on detection of at least one of the first user interaction and the second user interaction. Further, in an embodiment, the first handler may be specified using program code adhering to the predefined syntax.

Additionally, in an embodiment, defining the first handler may include a specification of one or more audio control parameters associated with playing of at least one of the first audio and the second audio. For instance, defining the first handler may include specifying a volume level at which at least one of the first audio file and the second audio file are played.

Further, the method comprises determining a current location of a pointer on the display with respect to the location at which the interactive user interface element is displayed on the display of the computing device.

In an embodiment, the location of the interactive user interface element at the display is assigned a reference value. In an exemplary embodiment, the display of the computing device may be a two dimensional (2D) display and reference value assigned to the interactive user interface element may be origin coordinates of the two dimensional display.

Further, the method comprises generating an audio signal based upon a relative location of the pointer with respect to the interactive user interface element. In an embodiment, the audio signal may be played at the computing device, so as to provide the user with an audio cue indicating a direction towards which, if the user moves the cursor, the interactive user interface element can be reached. In general, intensity of the audio signals may be dependent of the relative positions the interactive user interface and the pointer.

In an embodiment, the method further comprises identifying a background area of the display that substantially surrounds the interactive user interface element, partitioning the background area into a plurality of zones and identifying a given zone from amongst the plurality of zones in which the pointer is currently located, wherein the audio signal is generated based upon the given zone.

In another embodiment, the partitioning the background area into a plurality of zones may further comprises defining a third area outside the interactive user interface element, associating a third audio file with the third area, creating a third audio filter for the third area and forming an extended audio element by defining a second handler for playing the third audio file based on the association. The extended audio element typically comprises the audio element, the third area definition, the third audio file and the third audio filter. Details regarding defining the third area may be understood from the foregoing description of defining the first area. Further, in an embodiment, the defining of the third area may be performed automatically based on a predetermined rule. For example, the area may be automatically defined to be rectangular regions of a predetermined width surrounding four sides of the image.

Subsequently, in an embodiment, generating the audio signal based upon the given zone may thus include associating a third audio file with the third area. Details regarding associating the third audio file with the third area may be understood from the foregoing description of associating the first audio file with the first area. Accordingly, a third association between the third audio file and the third area may be created and stored in the storage device.

In an embodiment, a plurality of third areas may be defined around the interactive user interface element. For example, a developer may be enabled to define zones with origin in the middle of the interactive user interface element. Alternatively, defining of the plurality of third areas may start from the corner of the interactive user interface element. The area can be infinite with no ending within the sector or the area can be limited to end at the distance of for example 2-10 times diameter of the image.

Additionally, the method may include receiving an audio element comprising the webpage and a plurality of audio files and selecting an audio file from amongst the plurality of audio files to generate the audio signal. The method may also include detecting hovering of the pointer on the interactive user interface element and generating another audio signal based upon a portion of the interactive user interface element over which the pointer is hovering.

In an embodiment, the intensity of the audio signal may be directly proportional to the distance between the interactive user interface element and the pointer. In another embodiment, the intensity of the audio signal may be inversely proportional to the distance between the interactive user interface element and the pointer. Additionally, in an embodiment, the method may then include creating an audio filter for the audio signal based upon the relative location of the pointer with respect to the interactive user interface element. Further additionally, the method may include adjusting the audio filter as a function of a distance between the pointer and the interactive user interface element. In general, the audio filter may be configured to modify one or more characteristics of audio, such as, but not limited to, volume, frequency, directionality, channel etc. Further, in an embodiment, the audio filter may be configured to modify the one or more characteristics of audio based on user interaction occurring with the third zone. For example, the audio filter may be configured to modify the one or more characteristic of audio based on characteristics of user interaction, such as but not limited to, a type of user interaction, a speed of user interaction, a distance of user interaction from a reference point on the image etc.

In an embodiment, the content is might be a webpage.

Accordingly, in an embodiment, the audio filter may be a low pass filter. As a result, applying the audio filter on the third audio may result in suppression and/or elimination of low frequency components of the third audio. Further, parameters of the low pass filter such as for example, the cut-off frequency, frequency response, phase response etc. may predetermined. Additionally, the parameters of the low pass filter may be based on characteristics of user interaction occurring in the third area in real-time. For example, the developer may be enabled to specify how the cut-off frequency of the low pass filter varies based on distance of a user interaction, such as a mouse hovering, from a reference point on the image. In an embodiment, the low pass filter may be adjusted as function of relative distance between the position of the hovering and the image. Further, in an embodiment, the low pass filter may be configured to have an increased cut-off frequency with decreasing relative distance and decreased cut-off frequency with increasing relative distance. Accordingly, in an instance, hovering of the mouse in a region proximal to the image may set a higher cut-off frequency while hovering of the mouse in a region distal to the image may set a lower cut-off frequency.

Further, in an embodiment, the audio filter may be a volume controller. As a result, applying the audio filter on the third audio may result in increase or decrease of a volume of the third audio. Additionally, parameters of the volume controller may be based on characteristics of user interaction occurring in the third area in real-time. For example, the developer may be enabled to specify a level of volume varies based on distance of a user interaction, such as a mouse hovering, from a reference point on the image. Accordingly, in an instance, hovering of the mouse in a region proximal to the image may set a higher volume level while hovering of the mouse in a region distal to the image may set a lower volume level.

Further, as mentioned, the method may include forming an extended audio element by defining a second handler for playing the third audio file based on the association. Further, the second handler may be configured to apply the third audio filter on the third audio, for example, during playing of the third audio. Details regarding forming the extended audio element may be understood from the foregoing description of forming of the audio element.

In another aspect, an embodiment of the present disclosure provides a method of generating an audio signal in the user interface. The method comprises receiving the audio element comprising the image, the first audio file, the second audio file, the first association and the second association. Further, the first association associates the first audio file to the first area within the image and the second association associates the second audio file to the second area within the image. Additionally, the method comprises rendering the image in the user interface and detecting hovering of a pointer on the user interface. In an embodiment, based on the detecting, one or more of the first area and the second area may be zoomed in. Accordingly, a user may be able to perceive a greater visual detail in one or more of the first area and the second area of the user interface.

Furthermore, the method comprises generating a first audio signal based on the first audio file when the hovering takes place over the first area. Additionally, the method comprises generating a second audio signal based on the second audio file when the hovering takes place over the second area. As a result, a user interacting with the user interface may perceive different sounds depending on whether interaction occurs on the first area or the second area.

Additionally, in an embodiment, the method of generating the audio signal may further include receiving an extended audio element comprising a definition of the third area outside the image, an association of the third audio file with the third area and the third audio filter for the third area. In an embodiment, the third audio filter may be a low pass filter. Further, in another embodiment, the third audio filter may be a volume controller.

Further, this embodiment of the method includes detecting a hovering of a pointer on the user interface within the third area, determining a position of the hovering on the user interface within the third area and determining a relative distance between the position of the hovering and the image using the position of the hovering and the position of the image. Further, this embodiment of the method includes adjusting the third audio filter based on the relative distance. Furthermore, this embodiment includes applying the third audio filter to the third audio file and generating a third audio signal based on the third audio file and the applied third audio filter. For example, the third audio signal may be generated using a sound generating device, such as for example, a speaker.

In an embodiment, the filter is adjusted as function of relative distance between the position of the hovering and the image. In an embodiment, the third filter is a low pass filter that is configured to have an increased cut-off frequency with decreasing relative distance and decreased cut-off frequency with increasing relative distance.

The present disclosure enables different areas of a user interface element, such as an image, to be associated with different audio. Accordingly, when a user action such as a mouse hovering or a mouse click occurs on an area of the image, an audio associated with the area is generated. As a result, a richer user experience may be delivered to users in interacting with user interfaces. Further, users with various forms of visual impairment may be enabled to navigate user interfaces with greater convenience and/or accuracy.

Additionally, the present disclosure also enables an area outside a user interface element, such as the image, to be associated with a background audio. Accordingly, based on user interactions such as, mouse click or hovering, occurring in the area outside the image may result in playing of the background audio. As a result, engagement of users interacting with the user interface may be enhanced. For example, as a mouse pointer approaches towards the user interface element, playing of the background audio may function as an auditory cue to a user, thus increasing the user's attention towards the user interface element.

Further, the present disclosure also enables a plurality of background areas surrounding a user interface element to be associated with a corresponding plurality of background audio. As a result, for example, depending on a direction in which the mouse pointer approaches the user interface element, different corresponding audio may be played.

Furthermore, the present disclosure also enables applying of a filter to the background audio associated with the area outside the user interface element, wherein the filter may modify one or more parameters of the background audio based on a characteristic of the user's interaction. For example, the filter may include a distance based volume modifier configured to increase the volume of the background audio based on a proximity of the mouse pointer from the user interface element. As a result, when the user moves the mouse pointer towards the user interface, the user's attention may be gradually brought towards the user interface element without disturbing the user much while the mouse pointer is further away from the user interface element.

The present disclosure also relates to the method as described above. Various embodiments and variants disclosed above apply mutatis mutandis to the method.

Optionally, the location of the interactive user interface element at the display is assigned a reference value.

Optionally, the audio signal is to be played at the processing device, so as to provide the user with an audio cue indicating a direction towards which, if the user moves the cursor, the interactive user interface element can be reached.

Optionally, the method further comprises:
indentifying a background area of the display that substantially surrounds the interactive user interface element;
partioning the background area into a plurality of zones; and
indetifying a given zone from amongst the plurality of zones in which the pointer is currently located, wherein the audio signal is to be generated based upon the given zone.

Optionally, the method still further comprises:
receiving an audio element associated with the content and a plurality of audio files; and
selecting an audio file from amongst the plurality of audio files to generate the audio signal.

Optionally, the method yet further comprises:
detecting hovering of the pointer on the interactive user interface element; and
generating another audio signal based upon a portion of the interactive user interface element over which the pointer is hovering.

Optionally, the method further comprises creating an audio filter for the audio signal based upon the relative location of the pointer with respect to the interactive user interface element. In another embodiment, the method further comprises adjusting the audio filter as a function of a distance between the pointer and the interactive user interface element.

In alternative additional embodiment a present disclosure provides a method for generating an audio element for a user interface. The method comprises receiving an image, defining a first area within the image and associating a first audio file with the first area. Additionally, the method comprises defining a second area within the image and associating a second audio file with the second area. Furthermore, the method comprises forming the audio element by defining a first handler for playing at least the first or the second audio file based on the associations. The audio element comprises the image, the first audio file, the second audio file, the first association and the second association

In alternative or additional embodiment present disclosure provides a method of generating an audio signal in a user interface. The method comprises receiving an audio element comprising an image, a first audio file, a second audio file, a first association and a second association. Further, the first association associates the first audio file to a first area within the image and the second association associates the second audio file to a second area within the image. Additionally, the method comprises rendering the image in the user interface and detecting hovering of a pointer on the user interface. Furthermore, the method comprises generating a first audio signal based on the first audio file when the hovering takes place over the first area. Additionally, the method comprises generating a second audio signal based on the second audio file when the hovering takes place over the second area.

### DETAILED DESCRIPTION OF THE DRAWINGS

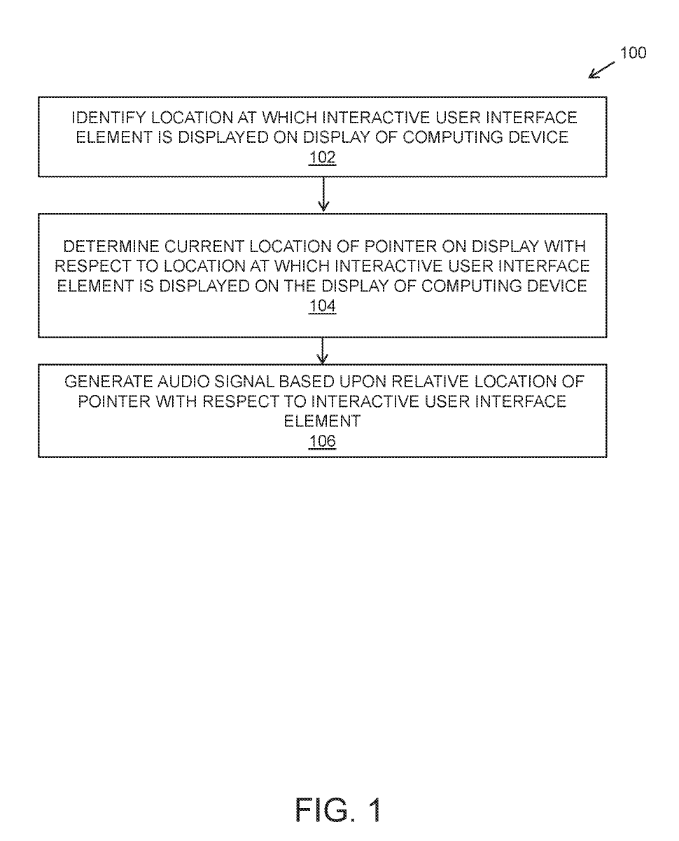

FIG. 1 is a schematic illustration of a method 100 of providing audio cues to a user of a content, the content being presented to the user on a computing device, the content comprising an interactive user interface element. At step 102 the method initiates, at the step 102 the method 100 includes identifying a location at which the interactive user interface element is displayed on a display of the computing device. At step 104 the method 100 includes determining a current location of a pointer on the display with respect to the location at which the interactive user interface element is displayed on the display of the computing device. Further, at step 106 the method 100 includes generating an audio signal based upon a relative location of the pointer with respect to the interactive user interface element.

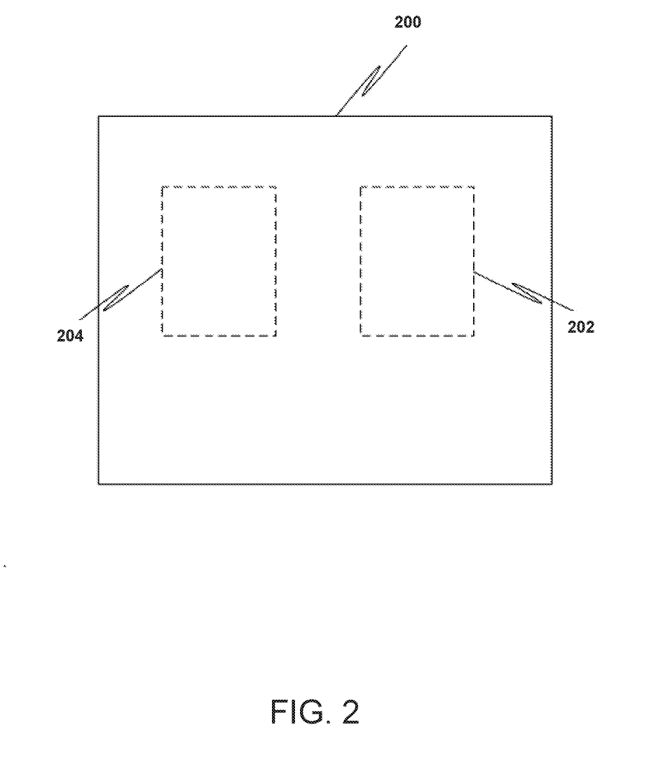

FIG. 2 is a schematic illustration of a user interface in which a content is rendered. The content comprising an image 200 including a first area 202 and a second area 204 configured to respectively play a first audio file and a second audio file, in accordance with an embodiment. As illustrated, each of the first area 202 and the second area 204 have been defined as rectangular regions, by a user, such as for example, a developer of the user interface. Further, the user interface is configured to generate audio based on user interactions occurring on the image. For instance, hovering of a mouse pointer over the first area 202 results in playing of the first audio file. Similarly, hovering of the mouse pointer over the second area 104 results in playing of the second audio file. Further, the first audio file is different from the second auditory file with regard to at least one auditory characteristic.

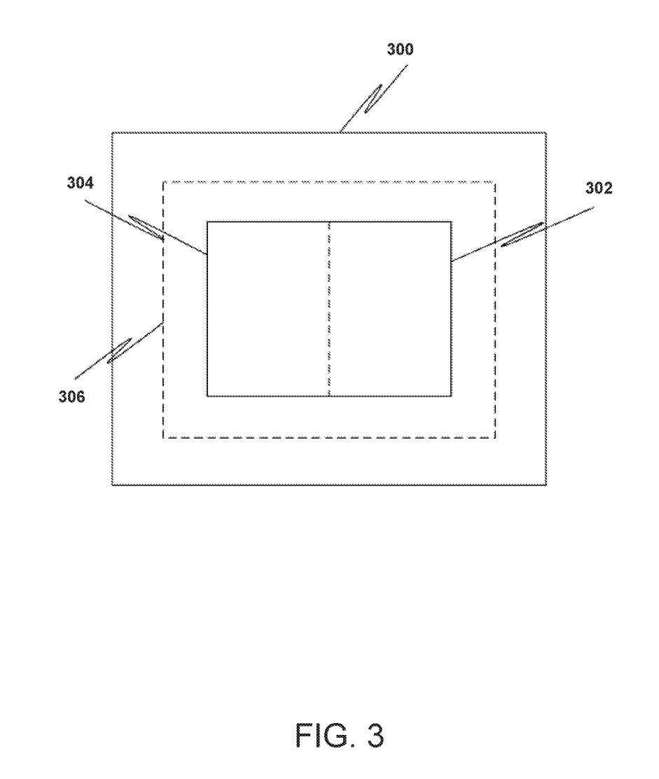

FIG. 3 is a schematic illustration of a user interface in which a content is rendered. The content comprising an image 300 including a first area 302, a second area 304 and a third area 306 outside the image 300 configured to respectively play a first audio file, a second audio file and a third audio file, in accordance with an embodiment. Each of the first area 302, the second area 304 and the third area 306 defined by a user, such as a developer of the user interface. Further, the user interface is configured to generate audio based on user interactions occurring on the image 300. For instance, hovering of a mouse pointer over the first area 302 results in playing of the first audio file. Similarly, hovering of the mouse pointer over the second area 304 results in playing of the second audio file. Likewise, hovering of the mouse pointer over the third area 306 results in playing of the third audio file. Further, the first audio file may be different from the second auditory file with regard to at least one auditory characteristic. Additionally, the third audio file may be different from one or more of the first audio file and the second audio file with regard to at least one auditory characteristic. Further, in an embodiment, the third audio file may be identical to one of the first audio file and the second audio file.

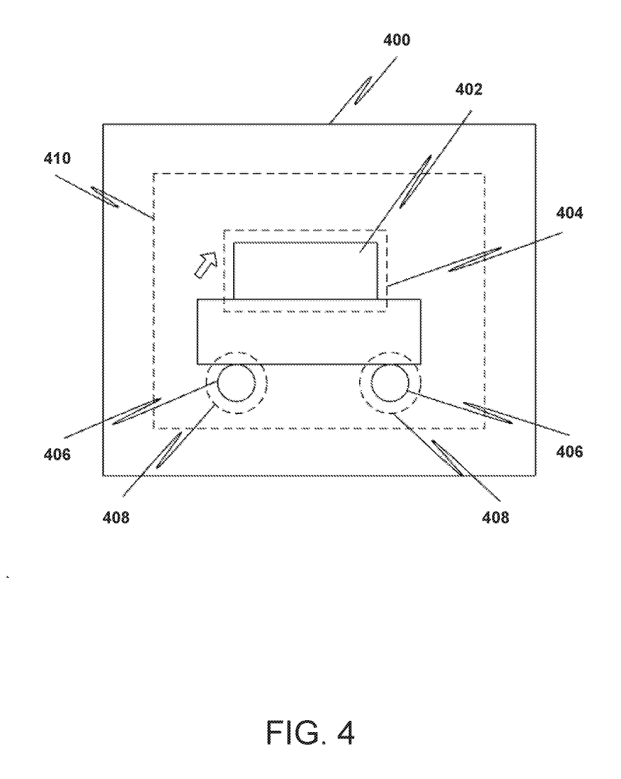

FIG. 4 is a schematic illustration of a content rendered on a user interface. The content comprising an image 400 including a plurality of areas associated with a plurality of audio files, in accordance with an exemplary embodiment. As illustrated, the image 400 represents an object such as a vehicle. Accordingly, a user such as a developer of the user interface may be enabled to define the plurality of areas corresponding to different portions of the object. For instance, an upper portion 402 of the object may be identified by the developer and accordingly a first area 404 may be defined to surround the upper portion 402. Similarly, wheel portions 406 may be identified and subsequently a plurality of second areas 408 surrounding the wheel portions 406 may be defined by the developer. Additionally, the image 400 includes definition of a third area 410 surrounding the object represented in the image. Further, hovering of a mouse pointer on one of the plurality of areas plays an associated audio file from the plurality of audio files. For example, hovering of the mouse pointer over the first area 404 may play an audio file containing description of the upper portion 402 of the object represented in the image 400. Similarly, hovering of the mouse pointer over one of the plurality of second areas 404 may play an audio file containing description of wheel portions 306. Likewise, hovering of the mouse pointer over the third area 410 may play an audio file containing a background music.

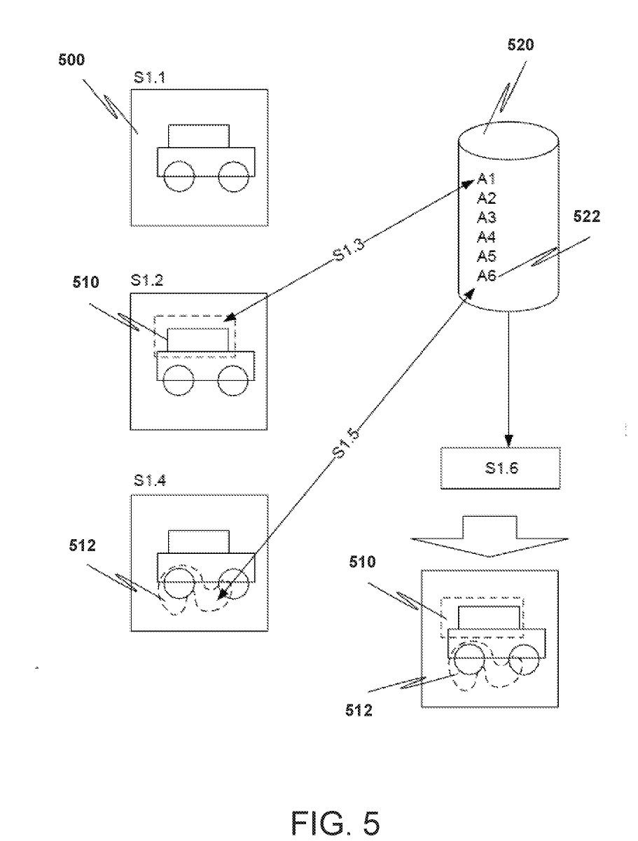

FIG. 5 is a schematic illustration of a method of associating a plurality of areas of an image 500 with a plurality of audio files, in accordance with an embodiment. In step S1.1, the image 500 is provided to a system. Further, in step S1.2 a developer of an audio object defines from the image 500, a first area 510. Subsequently, in step S1.3 the developer associates a first audio file A1 with the first area 510. Audio files are available in server 520 of the system. In present example, 6 different audio files, represented as, A1, A2, A3, A4, A5 and A6 are available. The audio files can be in any format, such as, for example MP3 format. Thereafter, in step S1.4 the developer defines from the image 500 a second area 512. The first area and the second area can be of arbitrary shape. Subsequently, in step S1.5 the developer associates a second audio file A6 with the second area 512. Thereafter, in step S1.6 an audio element is formed. In practice, a handler is defined which defines an action to the first and second area to be executed if mouse over hovering is detected. The action is playing the audio associated with an area where mouse hovering is detected.

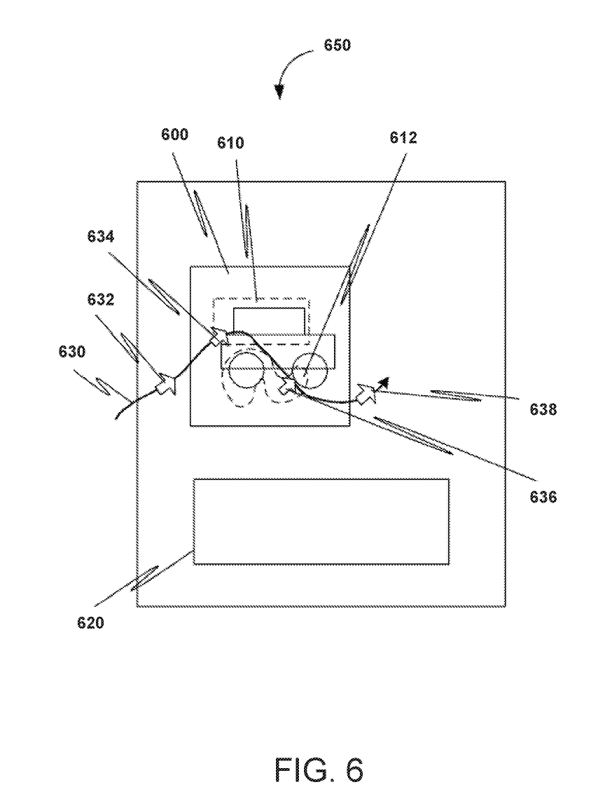

FIG. 6 is a schematic illustration of user interaction with a user interface comprising an image 600 including a plurality of areas and associated plurality of audio files, in accordance with an exemplary embodiment. In particular, FIG. 6 shows an example on how an audio object created with steps related to FIG. 5 is used in a web page 650.

Web page 650 comprises text 620 and the image 600. The image 600 is part of the audio object. In practice, the image 600 is associated with a script. The script downloads needed information related to the image 600 and information on how to handle mouse over hovering on the image 600. The script can be configured to also download all needed audio files.

Further, FIG. 6 illustrates a trajectory 630 of hovering a mouse over a content (rendered web page 650). The mouse pointer is shown at different positions (632, 634, 636, 638) along the trajectory 630. In position 632 the pointer is outside of the image 600. In position 634, the pointer is inside the image 600 and inside of area 610. Accordingly, audio associated with area 610 is played. The audio is either fetched when the hovering over area 610 takes place from the server or it can be preloaded to browser memory as the web page 650 is downloaded. When the mouse is in position 636, audio associated with the area 612 is played. In position 638, no audio is played.

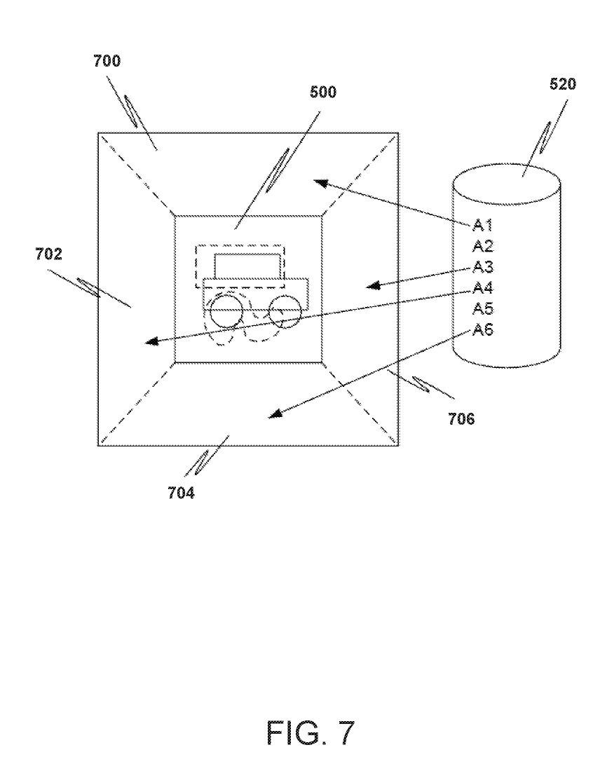

FIG. 7 is a schematic illustration of a user interface comprising an image 500 including a first plurality of areas within the image 500 and a second plurality of areas outside the image 500, wherein each of the first plurality of areas and the second plurality of areas are associated with a plurality of audio files, in accordance with an embodiment. Initially, an audio element is created for the image 500 according to steps of FIG. 5. Subsequently, additional area outside of the image 500 is defined, such as areas 700, 702, 704 and 706. The area definition can be for example defining sectors with origin in the middle of the image 500 or for example defining areas to start from the corner of the image 500 as shown. The area can be infinite with no ending within the sector or the area can be limited to end at the distance of for example 2-10 times diameter of the image 500.

For each of the areas outside of the image 500, audio files are associated. The audio files can be same or different which have been used in the audio element. In current example, audio file A1 is used for area 700 i.e. the same as associated with an area closest to the area 700 in the audio element. Audio file A4 is associated with area 702, A6 with area 705 and A3 with area 706. Further, an audio filter is defined for each of the areas 700, 702, 704 and 706. The audio filter can be volume or low pass or high pass filter or another filter used to modify audio.

The audio filter would change the volume setting of audio depending on how far away a hovering takes place from the image 500. Volume would increase as the hovering is closer to the image 500 and volume would decrease when the hovering is further away from the image 500.

Alternatively, the audio filter could be low pass filter. Cut off frequency of the low pass filter would be decreased as the distance of the hovering from the image 500 increases. In practice, when hovering takes place further away, low frequency sounds of associated audio file would dominate. Cut off frequency of the low pass filter would be increased as the distance of the hovering from the image 500 decreases.

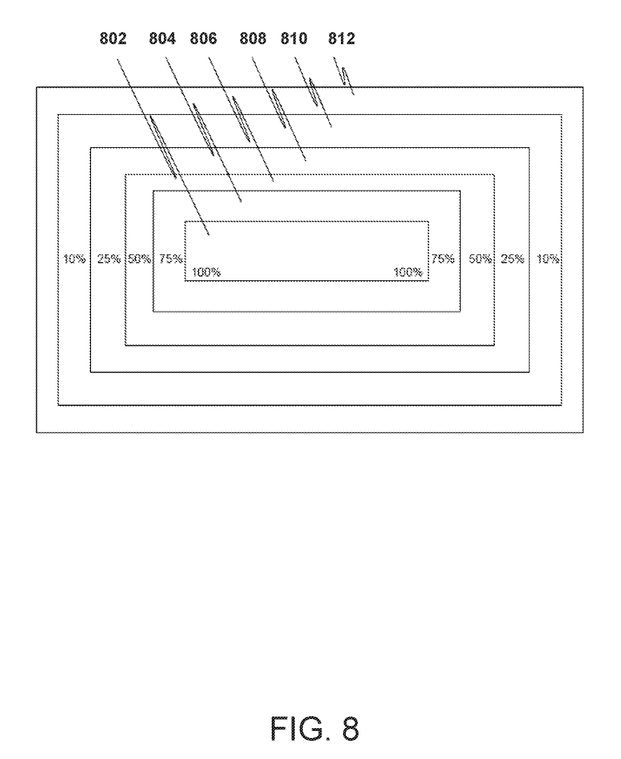

FIG. 8 is a schematic illustration of a user interface comprising an image 800 including a plurality of areas outside the image 800, wherein each of the plurality of areas is associated with a predetermined volume level, in accordance with an embodiment. As shown, areas 802, 804, 806, 808, 810 and 812 are defined surrounding the image 800, such as a logo. Further, the developer has defined volume levels corresponding to the areas 802, 804, 806, 808, 810 and 812 to be 100%, 75%, 50%, 25%, 10% and 0% respectively. Accordingly, an audio associated with the plurality of areas outside the image 800 may be played at different volumes depending on a position of a mouse pointer outside the image 800. For example, hovering of the mouse pointer in the area 802 would result in playing of the audio at 100% volume.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of providing audio cues to a user of a content, the content being presented to the user on a computing device, the content comprising an interactive user interface element, wherein the method comprises:
identifying a location at which the interactive user interface element is displayed on a display of the computing device;
determining a current location of a pointer on the display with respect to the location at which the interactive user interface element is displayed on the display of the computing device; and
generating an audio signal based upon a relative location of the pointer with respect to the interactive user interface element.

2. The method according to claim 1, wherein the location of the interactive user interface element at the display is assigned a reference value.

3. The method according to claim 1 or 2, wherein the audio signal is to be played at the computing device, so as to provide the user with an audio cue indicating a direction towards which, if the user moves the pointer, the interactive user interface element can be reached.

4. The method according to claim 1, further comprising:
identifying a background area of the display that substantially surrounds the interactive user interface element;
partitioning the background area into a plurality of zones; and
identifying a given zone from amongst the plurality of zones in which the pointer is currently located, wherein the audio signal is generated based upon the given zone.

5. The method according to claim 1, further comprising:
receiving an audio element associated with the content and a plurality of audio files; and
selecting an audio file from amongst the plurality of audio files to generate the audio signal.

6. The method according to claim 1, further comprising:
detecting hovering of the pointer on the interactive user interface element; and
generating another audio signal based upon a portion of the interactive user interface element over which the pointer is hovering.

7. The method according to claim 1, further comprising creating an audio filter for the audio signal based upon the relative location of the pointer with respect to the interactive user interface element.

8. The method according to claim 7, further comprising adjusting the audio filter as a function of a distance between the pointer and the interactive user interface element.

9. The method according to claim 7, wherein the audio filter is a low pass filter.

10. The method according to claim 7, wherein the audio filter is a volume controller.

11. The method according to claim 1, wherein the content is a web page.

12. A computer program product comprising a non-transitory machine-readable data storage medium having stored thereon program instructions that, when accessed by a processing device, cause the processing device to:
identify a location at which the interactive user interface element is displayed on a display of the computing device;
determine a current location of a pointer on the display with respect to the location at which the interactive user interface element is displayed on the display of the computing device; and
generate an audio signal based upon a relative location of the pointer with respect to the interactive user interface element.

13. The computer program product according to claim 12, wherein the location of the interactive user interface element at the display is assigned a reference value.

14. The computer program product according to claim 12, wherein the audio signal is to be played at the processing device, so as to provide the user with an audio cue indicating a direction towards which, if the user moves the pointer, the interactive user interface element can be reached.

15. The computer program product according to claim 12, wherein, when accessed by the processing device, the program instructions cause the processing device to:
identify a background area of the display that substantially surrounds the interactive user interface element;
partition the background area into a plurality of zones; and
identify a given zone from amongst the plurality of zones in which the pointer is currently located, wherein the audio signal is to be generated based upon the given zone.

16. The computer program product according to claim 12, wherein, when accessed by the processing device, the program instructions cause the processing device to:
receive an audio element associated with the content and a plurality of audio files; and
select an audio file from amongst the plurality of audio files to generate the audio signal.

17. The computer program product according to claim 12, wherein, when accessed by the processing device, the program instructions cause the processing device to:
detect hovering of the pointer on the interactive user interface element; and
generate another audio signal based upon a portion of the interactive user interface element over which the pointer is hovering.

18. The computer program product according to claim 12, wherein, when accessed by the processing device, the program instructions cause the processing device to create an audio filter for the audio signal based upon the relative location of the pointer with respect to the interactive user interface element.

19. The computer program product according to claim 12, wherein, when accessed by the processing device, the program instructions cause the processing device to adjust the audio filter as a function of a distance between the pointer and the interactive user interface element.
